(19) United States
(12) Patent Application Publication
(10) Pub. No.: US 2004/0217993 A1
(43) Pub. Date: Nov. 4, 2004

(54) Numbering device for specimen holders

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/819,174

(22) Filed: Apr. 7, 2004

(30) Foreign Application Priority Data
Apr. 30, 2003 (JP) 2003-125506

(51) Int. Cl. B41J 3/00

(52) U.S. Cl. 347/2

(57) ABSTRACT

A specimen holder numbering device comprises a specimen holder carry-in section which carries in a specimen holder, an identification number printing section and a specimen holder carry-out section. The identification number printing section prints a particular identification number on the specimen holder carried in by the specimen holder carry-in section. The identification number printing section includes an ink-jet painting unit for coating the outer peripheral surface of the specimen holder with an undercoating color, and an ink-jet printing unit for printing the particular identification number on the specimen holder coated with the undercoating color. The specimen holder carry-out section sorts out the specimen holder in accordance with the identification number printed thereon, and carries out the sorted specimen holder.

### CROSS-REFERENCE TO RELATED APPLICATIONS

This application is based upon and claims the benefit of priority from prior Japanese Patent Application No. 2003-125506, filed Apr. 30, 2003, the entire contents of which are incorporated herein by reference.

### BACKGROUND OF THE INVENTION

1. Field of the Invention

The present invention relates to a specimen holder numbering device for printing identification numbers on the peripheral surfaces of specimen holders, such as blood sample tubes, using an ink-jet printing unit.

2. Description of the Related Art A numbering device for printing identification numbers on printing targets using an ink-ribbon printing unit is known (see Patent Document 1). Another numbering device that uses a laser is also known (see Patent Document 2).

[Patent Document 1]

Jpn. Pat. Appln. KOKAI Publication No. 2002-370434 (see, in particular, section [0017]; FIG. 1)

[Patent Document 2]

Jpn. Pat. Appln. KOKAI Publication No. 10-147002 (see, in particular, section [0007]; FIG. 1)

The numbering devices disclosed in Patent Documents 1 and 2 exhibit the following disadvantages when they print numbers on specimen holders such as blood sample tubes: It is difficult for the numbering device using an ink-ribbon printing unit to print numbers on cylindrical specimen holders, such as blood sample tubes. On the other hand, in the case of the numbering device using a laser, the heat resistance of blood sample tubes that are generally formed of glass may raise a problem. Even if this problem is overcome, when the specimen holders are formed of transparent glass or plastic, the identification numbers printed thereon are hard to see. However, if these holders are formed of colored glass or plastic, they are expensive.

The present invention has been developed in light of these circumstances, and aims to provide a specimen holder numbering device having the following advantages:

(a) Even if the specimen holders are formed of transparent glass or plastic, the identification numbers printed thereon are highly visible; and

(b) The expense entailed in producing specimen holders can be reduced.

### BRIEF SUMMARY OF THE INVENTION

A specimen holder numbering device according to the invention is characterized by comprising: a specimen holder carry-in section which carries in a specimen holder; an identification number printing section which prints a particular identification number on the specimen holder carried in by the specimen holder carry-in section, the identification number printing section including an ink-jet painting unit configured to coat an outer peripheral surface of the specimen holder with an undercoating color, and an ink-jet printing unit configured to print the particular identification number on the specimen holder coated with the undercoating color; and a specimen holder carry-out section which sorts out the specimen holder in accordance with the identification number printed thereon, and carries out the sorted specimen holder.

Additional objects and advantages of the invention will be set forth in the description which follows, and in part will be obvious from the description,. or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1A is a schematic perspective view illustrating a numbering device for specimen holders according to an embodiment of the invention;

FIG. 1B is a schematic plan view illustrating the positional relationship between specimen-holder processing sections;

FIG. 2A is a block diagram illustrating the function of the numbering device of the embodiment; and

FIG. 2B is a flowchart useful in explaining the operation of an identification number printing section.

### DETAILED DESCRIPTION OF THE INVENTION

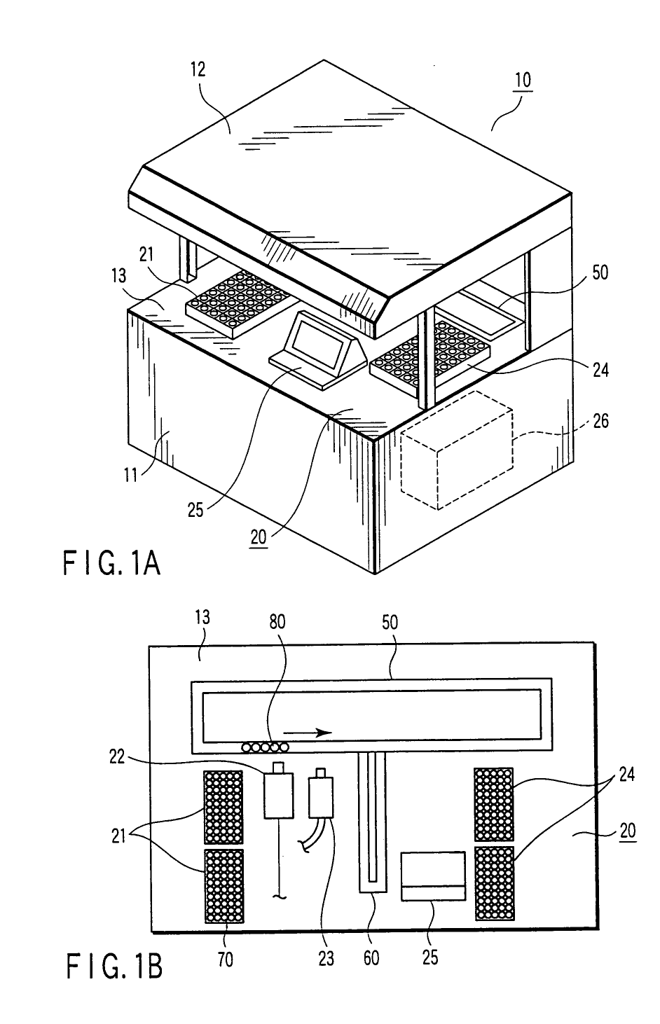

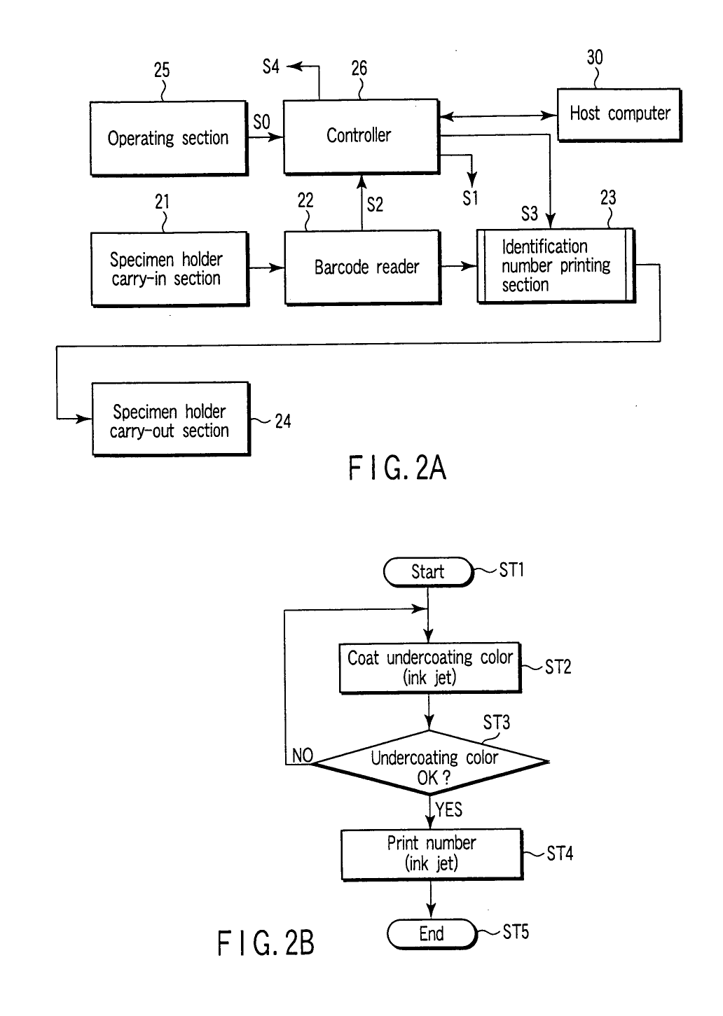

FIG. 1A is a schematic perspective view illustrating a numbering device for specimen holders according to an embodiment of the invention. FIG. 1B is a schematic plan view illustrating the positional relationship between specimen-holder processing sections. FIG. 2A is a block diagram illustrating the function of the numbering device of the embodiment. FIG. 2B is a flowchart useful in explaining the operation of an identification number printing section.

As shown in FIGS. 1A, 1B, 2A and 2B, the numbering device 10 for specimen holders according to the embodiment of the invention comprises a casing 11 and upper cover 12. The casing 11 has a work table 13. A specimen holder processing section 20 described below is provided on the work table 13 and in the casing 11.

A specimen holder carry-in section 21, barcode reader 22, identification number printing section 23, specimen holder carry-out section 24 and operating section 25 are provided on the upper surface of the work table 13. The casing 11 contains a controller 26 and power supply (not shown).

The specimen holder carry-in section 21 carries in a plurality of to-be-numbered specimen holders 70 from the outside, and sets them in an installed rack. The holders 70 set in the rack of the carry-in section 21 are transferred in units of, for example, five holders by a robot arm (no shown) onto a specimen holder container 80 on a belt conveyer line 50. After that, the holders 70 are moved, together with the container 80, on the line 50 in the direction indicated by the arrow.

The barcode reader 22 sequentially reads the barcodes attached to the outer peripheral surfaces of the specimen holders 70 conveyed on the line 50.in the direction indicated by the arrow. The read barcodes are supplied to a host computer 30 via the controller 26 described later.

The identification number printing section 23 prints particular identification numbers on the specimen holders 70 in accordance with specimen information supplied from the host computer 30 via the controller 26. The identification number printing section 23 has an ink-jet painting unit for coating the outer peripheral surface of each specimen holder 70 with an undercoating color, and an ink-jet printing unit for printing a particular identification number on each specimen holder 70 coated with the undercoating color.

The specimen holder carry-out section 24 distributes the specimen holders 70 to, for example, a rack for an analysis apparatus, and a user-designated rack, based on the identification numbers printed by the identification number printing section 23.

The operating section 25 includes a display and keyboard. An instruction signal SO generated by the operation of the keyboard is supplied to the controller 26.

Upon receiving the instruction signal SO, the controller 26 comprises a CPU, and supplies a sequence control P signal S1 to the specimen holder carry-in section 21, barcode reader 22, identification number printing section 23 and specimen holder carry-out section 24, thereby performing sequence control.

Further, when the controller 26 has received a barcode reading signal S2 from the barcode reader 22, it accesses the host computer 30 to acquire specimen information corresponding to the read barcode. Upon receiving the specimen information, the controller 26 supplies the identification number printing section 23 with a print control signal S3 indicating the acquired specimen information.

Further, when the controller 26 has received, from the barcode reader 22, a signal indicating that no barcode could be read, or when specimen information corresponding to the read barcode is not supplied from the host computer 30, the controller 26 outputs an error signal S4. When the error signal S4 is output, the corresponding specimen holder 70 is automatically transferred to an error lane 60, and a message indicating this is reported to an operator.

Referring to the flowchart of FIG. 4, the operation of the identification number printing section 23 will be described.

Step ST1: Upon receiving the printing control signal S3, the identification number printing section 23 starts its operation.

Step ST2: The ink-jet painting unit operates to coat a predetermined outer peripheral surface region of each specimen holder 70 with an undercoating color such as white.

Step ST3: It is determined whether the undercoating color, white, is satisfactorily coated. If the undercoating color is not satisfactorily coated, the process is returned to the step ST2. If the undercoating color is satisfactorily coated, the process proceeds to the next step S4.

Step ST4: The ink-jet printing unit prints data, which corresponds to the specimen information from the host computer 30, on the white-coated region, using, for example, black ink.

Step ST5: A series of numbering operations are completed.

The undercoating color may be black, and the printing color be white. The combination of black and white makes the printed number data conspicuous. As a result, the printed identification numbers can be read accurately. The color combination is not limited to the above, but it is preferable that the to-be-selected undercoating and printing colors have a spectral difference of 70 nanometers or more. If the colors satisfy this condition, they can be clearly recognized. Therefore, even if they are similar colors, the printed number can be read accurately.

(Features of the Embodiment)

(1) The specimen holder numbering device 10 employed in the embodiment is characterized by comprising:

the specimen holder carry-in section 21 which carries in the specimen holders 70;

the identification number printing section 23 which prints a particular identification number on each specimen holder 70 carried in by the specimen holder carry-in section 21, the identification number printing section including the ink-jet painting unit configured to coat an outer peripheral surface of each specimen holder with an undercoating color, and the ink-jet printing unit configured to print the particular identification number on each specimen holder coated with the undercoating color; and

the specimen holder carry-out section 24 which sorts out each specimen holder 70 in accordance with the identification number printed thereon, and carries out the sorted specimen holder.

Since the numbering device 10 constructed as above has the ink-jet painting unit and ink-jet printing unit, it can perform printing reliably even if the printing target is, for example, a cylindrical glass specimen holder 70. In particular, since the specimen holder 70 is coated with an underlayer color before an identification number is printed on the holder, even if the holder 70 is formed of transparent glass or plastic, the identification number printed is highly visible. In addition, it is not necessary to use a colored material as the material of the specimen holder 70, which reduces the expense entailed in producing the holder 70.

(2) The specimen holder numbering device 10 employed in the embodiment is characterized by comprising:

the specimen holder carry-in section 21 which carries in the specimen holders 70;

the barcode reader 22 which reads a barcode provided on each specimen holder 70 carried in by the specimen holder carry-in section 21;

the identification number printing section 23 which prints a particular identification number on each specimen holder 70 in accordance with the barcode read by the barcode reader 22, the identification number printing section including the ink-jet painting unit configured to coat an outer peripheral surface of each specimen holder with an undercoating color, and the ink-jet printing unit configured to print the particular identification number on each specimen holder coated with the undercoating color; and

the specimen holder carry-out section 24 which sorts out each specimen holder 70 in accordance with the identification number printed thereon, and carries out the sorted specimen holder.

(3) The specimen holder numbering device 10 employed in the embodiment and described in (1) or (2) is also characterized in that the undercoating color and the color of the particular identification number are black and white, respectively, or vice versa.

Since in the numbering device 10, the undercoating color and printing color show high contrast, the identification number printed can be read accurately.

(4) The specimen holder numbering device 10 employed in the embodiment and described in (1) or (2) is also characterized in that the undercoating color and the color of the particular identification number have a spectral difference of 70 nanometers or more.

In this case, the undercoating color and printing color show such contrast as enables the colors to be distinguished from each other. Therefore, even if the colors are similar ones, the identification number printed can be read accurately.

(5) The specimen holder numbering device 10 employed in the embodiment and described in (1) to (4) is also characterized in that the specimen holder is a blood sample tube.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A specimen holder numbering device comprising:
a specimen holder carry-in section which carries in a specimen holder;
an identification number printing section which prints a particular identification number on the specimen holder carried in by the specimen holder carry-in section, the identification number printing section including an ink-jet painting unit configured to coat an outer peripheral surface of the specimen holder with an undercoating color, and an ink-jet printing unit configured to print the particular identification number on the specimen holder coated with the undercoating color; and
a specimen holder carry-out section which sorts out the specimen holder in accordance with the identification number printed thereon, and carries out the sorted specimen holder.

2. A specimen holder numbering device comprising:
a specimen holder carry-in section which carries in a specimen holder;
a barcode reader which reads a barcode provided on the specimen holder carried in by the specimen holder carry-in section;
an identification number printing section which prints a particular identification number on the specimen holder in accordance with the read barcode, the identification number printing section including an ink-jet painting unit configured to coat an outer peripheral surface of the specimen holder with an undercoating color, and an ink-jet printing unit configured to print the particular identification number on the specimen holder coated with the undercoating color; and
a specimen holder carry-out section which sorts out the specimen holder in accordance with the identification number printed thereon, and carries out the sorted specimen holder.

3. The specimen holder numbering device according to claim 1, wherein the undercoating color and a color of the particular identification number are black and white, respectively, or vice versa.

4. The specimen holder numbering device according to claim 1, wherein the undercoating color and a color of the particular identification number have a spectral difference of 70 nanometers or more.

5. The specimen holder numbering device according to claim 1, wherein the specimen holder is a blood sample tube.
